(19) United States
(12) Patent Application Publication
(10) Pub. No.: US 2026/0051172 A1
(43) Pub. Date: Feb. 19, 2026

(54) TRAIN INTERIOR MONITORING SYSTEM AND TRAIN INTERIOR MONITORING METHOD

(71) Applicant: Mitsubishi Electric Corporation, Chiyoda-ku, Tokyo (JP)

(72) Inventor: Takahiro ITO, Tokyo (JP)

(73) Assignee: Mitsubishi Electric Corporation, Chiyoda-ku, Tokyo (JP)

(21) Appl. No.: 19/101,069

(22) PCT Filed: Oct. 24, 2022
(86) PCT No.: PCT/JP2022/039444

§ 371 Date: Feb. 4, 2025

(51) Int. Cl. G06V 20/52; B61L 15/00; G06V 10/94; G06V 20/40; G06V 40/10

(52) U.S. Cl. CPC G06V 20/52; B61L 15/0018; B61L 15/0072; B61L 15/009; G06V 10/94; G06V 20/40; G06V 40/10

(57) ABSTRACT

A train interior monitoring system includes an on-board video storage unit that stores, as image information, video data of an interior of trains and parameter information; an on-board control unit that controls operations of devices installed on the trains; an on-board display unit that provides a display; an on-board communication unit that sends the image information stored in the on-board video storage unit when one of the trains is in a stoppage state; and a video analysis server that determines whether there is a left-behind article on each of the trains using the image information, and when the video analysis server detects presence of a left-behind article, generates a left-behind article notification indicating that there is a left-behind article. The on-board display unit displays contents of the left-behind article notification.

### FIELD

The present disclosure relates to a train interior monitoring system and a train interior monitoring method each for monitoring a train interior.

### BACKGROUND

A train interior is conventionally monitored using a device such as a camera in a running train. For example, Patent Literature 1 discloses a technology in which a local system installed on a train captures images of a train interior using multiple cameras, and sends the captured images and the like to a host system installed on the ground, while the host system on the ground controls, as needed, the magnification, the image shooting direction, and the like of the cameras to detect a situation such as presence of a left-behind article on the train.

### CITATION LIST

### Patent Literature

Patent Literature 1: Japanese Patent Application Laid-open No. 2001-285842

### SUMMARY OF INVENTION

### Problem to be Solved by the Invention

However, according to the conventional technology described above, the local system on the train sends images captured by multiple cameras and the like to the host system on the ground in real time during normal train operation, while the host system on the ground sends, to the local system on the train, a control signal for controlling the magnification, the image shooting direction, and the like of the cameras. This presents a problem in that a significantly large amount of data of communication is generated between the local system on the train and the host system on the ground during normal train operation. In particular, a system that controls train operation using wireless communication between the train and a device on the ground may be subjected to a delay or the like in wireless communication during running of the train, which may affect regular running of the train. A smaller amount of data of communication is therefore preferred that has no direct effect on the running of the train.

The present disclosure has been made in view of the above, and it is an object of the present disclosure to provide a train interior monitoring system capable of detecting a left-behind article present on a train while reducing the amount of data of communication during running of the train.

### Means to Solve the Problem

In order to solve the above-described problems and achieve the object, a train interior monitoring system according to the present disclosure includes: an on-board video storage unit to store, as image information, video data and parameter information, the video data obtained by shooting an interior of a train using a surveillance camera, the parameter information representing a situation of obtaining the video data by shooting; an on-board control unit to control operation of a device installed on the train; an on-board display unit to provide a display under control of the on-board control unit; an on-board communication unit to send, under control of the on-board control unit, the image information stored in the on-board video storage unit to a ground communication unit when the train is in a stoppage state; the ground communication unit to receive the image information sent from the on-board communication unit; and a video analysis server to determine whether there is a left-behind article on the train using the image information received by the ground communication unit. When the video analysis server detects presence of the left-behind article, the video analysis server generates a left-behind article notification indicating that there is the left-behind article. The ground communication unit sends the left-behind article notification to the on-board communication unit. The on-board communication unit receives the left-behind article notification. The on-board display unit displays, under control of the on-board control unit, a content of the left-behind article notification received by the on-board communication unit.

### Effects of the Invention

A train interior monitoring system according to the present disclosure provides an advantage in capability of detecting a left-behind article present on a train while reducing the amount of data of communication during running of the train.

### BRIEF DESCRIPTION OF DRAWINGS

FIG. 1 is a diagram illustrating an exemplary configuration of a train interior monitoring system according to a first embodiment.

FIG. 2 is a flowchart illustrating an operation of the train interior monitoring system according to the first embodiment.

FIG. 3 is a diagram illustrating an example of a configuration of processing circuitry of the train interior monitoring system according to the first embodiment when the processing circuitry is implemented by a processor and a memory.

FIG. 4 is a diagram illustrating an example of a configuration of the processing circuitry of the train interior monitoring system according to the first embodiment when the processing circuitry is implemented in a dedicated hardware element.

FIG. 5 is a flowchart illustrating an operation of the train interior monitoring system according to a second embodiment.

FIG. 6 is a flowchart illustrating an operation of the train interior monitoring system according to a third embodiment.

### DESCRIPTION OF EMBODIMENTS

A train interior monitoring system and a train interior monitoring method according to embodiments of the present disclosure will be described in detail below with reference to the drawings.

### First Embodiment

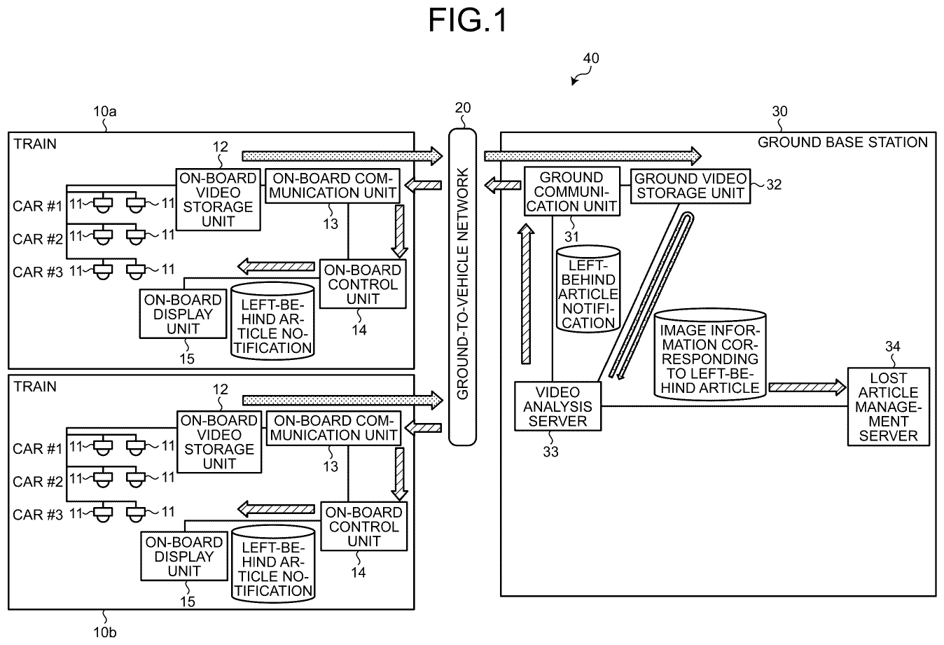

FIG. 1 is a diagram illustrating an exemplary configuration of a train interior monitoring system 40 according to a first embodiment. The train interior monitoring system 40 includes trains 10a and 10b, a ground-to-vehicle network 20, and a ground base station 30. The trains 10a and 10b are configured similarly to each other. The trains 10a and 10b may each be hereinafter referred to as train 10 when no distinction is to be made therebetween. Although the train interior monitoring system 40 includes two of the trains 10 in the example of FIG. 1, the configuration thereof is not limited to this. The number of the trains 10 included in the train interior monitoring system 40 may be one or three or more.

A configuration and an operation of the train 10 will first be described. As illustrated in FIG. 1, each of the trains 10 (hereinafter referred to simply as train 10) includes multiple surveillance cameras 11 (or security cameras), an on-board video storage unit 12, an on-board communication unit 13, an on-board control unit 14, and an on-board display unit 15.

The surveillance cameras 11 are installed in each of the vehicles that constitute the train 10 to shoot the interior, i.e., the vehicle interior, of the train 10. The example of FIG. 1 illustrates an example in which the train 10 is a three-car train, and two of the surveillance cameras 11 are installed in each vehicle. The configuration thereof is, however, not limited to this. The number of the surveillance cameras 11 installed in each vehicle of the train 10 may be one or three or more. The train 10 includes, in each vehicle, the surveillance cameras 11 whose installation positions, image shooting directions, and the like have been adjusted to eliminate a blind spot in the shooting area. Thus, on the train 10, the number of the surveillance cameras 11 installed in each vehicle may differ depending on the vehicle according to factors such as the seat layout of the vehicle. Each of the surveillance cameras 11 is given identification information to identify the corresponding one of the surveillance cameras 11. Each of the surveillance cameras 11 is also given information of car number to identify the vehicle in which the corresponding one of the surveillance cameras 11 is installed. Each of the surveillance cameras 11 shoots an interior of the train 10 with a predetermined period, and outputs video data obtained by shooting the interior of the train 10, to the on-board video storage unit 12, together with the identification information and the information of car number.

The on-board video storage unit 12 stores, as image information, the video data obtained by shooting using the surveillance cameras 11, obtained from the surveillance cameras 11, together with parameter information representing the situation of obtaining the video data by shooting. The parameter information includes information of the shooting time and the like, as well as the identification information and the information of car number of each of the surveillance cameras 11 described above. The information of the shooting time may be information of the time when each of the surveillance cameras 11 actually shot an interior of the train 10, that is output to the on-board video storage unit 12 as the information of the shooting time together with the identification information and the information of car number, or may be the time of acquisition of the video data from each of the surveillance cameras 11 by the on-board video storage unit 12, whose information is processed in such a manner that the on-board video storage unit 12 regards such time of acquisition as the information of the shooting time, adds the information of the shooting time to the information obtained from the corresponding one of the surveillance cameras 11, and stores the resulting information. Note that the example of FIG. 1 illustrates a case where each of the trains 10 includes a single on-board video storage unit 12, but the configuration thereof is not limited to this. In a case where the train 10 has a long formation such as when the train 10 is constituted by 16 cars, the train 10 may include multiple on-board video storage units 12, and each vehicle of the train 10 may include an on-board video storage unit 12. The on-board video storage unit 12 installed in each vehicle may add the information of car number to the information obtained from the corresponding one of the surveillance cameras 11, and store the resulting information.

The on-board communication unit 13 communicates with a ground communication unit 31, described later, included in the ground base station 30, which is installed on the ground, via the ground-to-vehicle network 20. The ground-to-vehicle network 20 may be a private network of the railroad company that operates the trains 10 or a public network such as the Internet.

The on-board control unit 14 controls operations of devices installed on the train 10. The devices installed on the train 10 are, for example, but not limited to, the multiple surveillance cameras 11, the on-board video storage unit 12, the on-board communication unit 13, and the on-board display unit 15 illustrated in FIG. 1 and the like. The on-board control unit 14 controls operations of devices related to running of the train 10, such as a brake (not illustrated) included in the train 10, and operations of doors, an air conditioner (each not illustrated), and the like included in the train 10.

The on-board display unit 15 provides a display under control of the on-board control unit 14. The on-board display unit 15 is a display device installed in a cab of the train 10 and/or the like to allow the driver, the conductor, and the like working on the train 10 to check display contents.

In the first embodiment, the on-board control unit 14 performs control to send the image information stored in the on-board video storage unit 12 from the on-board communication unit 13 to the ground communication unit 31 included in the ground base station 30 installed on the ground, via the ground-to-vehicle network 20, when the train 10 is in a stoppage state. That is, the on-board communication unit 13 sends, under control of the on-board control unit 14, the image information stored in the on-board video storage unit 12 to the ground communication unit 31 included in the ground base station 30 installed on the ground when the train 10 is in a stoppage state. In the first embodiment, the stoppage state of the train 10 is a state in a time after operation of the train 10 has finished and all the passengers have got off the train 10, and when the train 10 is returning to a place such as a train shed in an operation mode such as “not in service”.

Since the on-board control unit 14 controls operations of devices installed on the train 10 as described above, the on-board control unit 14 can recognize the time of finishing of the operation of the train 10 based on an operation such as, for example, a change in the destination sign displayed on the lead vehicle of the train 10 or the like to “not in service”. In this case, the on-board communication unit 13 sends, under control of the on-board control unit 14, the image information stored in the on-board video storage unit 12 during a time period from the start of operation to the finishing of the operation of the train 10, to the ground communication unit 31 included in the ground base station 30.

For example, if the train 10 sends, in real time, the image information including video data obtained by shooting using each of the surveillance cameras 11 to the ground base station 30 installed on the ground each time a video is shot by one of the surveillance cameras 11, video data would also be sent during running of the train 10. In this case, a greater number of the surveillance cameras 11 included in the train 10 would cause a larger amount of data of image information to be sent from the train 10 to the ground base station 30 installed on the ground during running of the train 10. In a case where the train 10 is operated in a system that controls the operation of the train 10 using wireless communication between the train 10 and the ground base station 30, there will be a possibility that image information sent by the train 10 may cause congestion in communication between the train 10 and the ground base station 30, thereby affecting running of the train 10. Accordingly, in the first embodiment, the on-board control unit 14 performs control to send the image information stored in the on-board video storage unit 12 from the on-board communication unit 13 to the ground base station 30 installed on the ground, via the ground-to-vehicle network 20, when the train 10 is in a stoppage state. This enables the on-board control unit 14 to avoid a situation such as congestion in communication between the train 10 and the ground base station 30.

Note that the train interior monitoring system 40 assumes that multiple trains 10 send image information to the ground base station 30. Thus, each of the trains 10 may include information of train number that allows identification of that one of the trains 10 in the parameter information in the image information, or may add information of train number that allows identification of the sending train 10 to the image information when the on-board communication unit 13 sends the image information, and send the resulting information to the ground base station 30.

A configuration and an operation of the ground base station 30 will next be described. As illustrated in FIG. 1, the ground base station 30 includes the ground communication unit 31, a ground video storage unit 32, a video analysis server 33, and a lost article management server 34.

The ground communication unit 31 receives image information sent from the on-board communication unit 13 of the train 10 via the ground-to-vehicle network 20. The ground communication unit 31 outputs the image information received, to the ground video storage unit 32.

The ground video storage unit 32 stores the image information received by the ground communication unit 31. Since the ground communication unit 31 obtains the image information from the multiple trains 10, the ground video storage unit 32 stores the image information on a per-train 10 basis. Note that when the image information sent from the on-board communication unit 13 of the train 10 and received by the ground communication unit 31 has an amount of data that can be obtained and processed at one time by the video analysis server 33, the ground base station 30 does not need to include the ground video storage unit 32. In this case, the ground communication unit 31 outputs the image information received, to the video analysis server 33.

The video analysis server 33 determines whether there is a left-behind article on the train 10 using the image information received by the ground communication unit 31 and stored in the ground video storage unit 32. When the ground base station 30 does not include the ground video storage unit 32 as described above, the video analysis server 33 determines whether there is a left-behind article on the train 10 using the image information received by the ground communication unit 31 and obtained from the ground communication unit 31. The video analysis server 33 is assumed to have already been trained using machine learning or the like to allow a passenger's belonging or the like that is left on a seat, an overhead rack, or the like of the train 10 to be detected as a left-behind article when such article exists. Possible examples of the left-behind article include, but not limited to, a bag, a thing in a paper bag, an umbrella, and the like. In addition, the technique of machine learning used for the video analysis server 33 may be a commonly-used learning method, and is not particularly limited. When the video analysis server 33 detects a left-behind article, the video analysis server 33 generates a left-behind article notification indicating that there is a left-behind article, and causes the ground communication unit 31 to send the left-behind article notification generated, to the on-board communication unit 13 of the corresponding one of the trains 10 via the ground-to-vehicle network 20. That is, the ground communication unit 31 sends the left-behind article notification generated by the video analysis server 33 to the on-board communication unit 13 of the corresponding one of the trains 10 via the ground-to-vehicle network 20. The left-behind article notification contains information of car number indicating the vehicle that constitutes the train 10 for allowing identification of the location of the left-behind article, among the parameter information corresponding to video data of the left-behind article that has been shot. The left-behind article notification may further contain the video data of the left-behind article that has been shot. In addition, when the video analysis server 33 detects a left-behind article, the video analysis server 33 outputs image information corresponding to the left-behind article to the lost article management server 34.

The lost article management server 34 stores the image information corresponding to the left-behind article. The lost article management server 34 stores the image information corresponding to the left-behind article at least until the left-behind article is retrieved by a passenger or until a predetermined storage period elapses with the left-behind article not retrieved by a passenger. When the left-behind article is retrieved by a passenger or when a predetermined storage period has elapsed with the left-behind article not retrieved by a passenger, the lost article management server 34 may delete the image information corresponding to the left-behind article according to an applicable rule.

On the train 10, the on-board communication unit 13 receives a left-behind article notification sent from the ground communication unit 31 of the ground base station 30 via the ground-to-vehicle network 20, and outputs the left-behind article notification to the on-board control unit 14. The on-board control unit 14 causes the on-board display unit 15 to display contents of the left-behind article notification received by the on-board communication unit 13. That is, the on-board display unit 15 displays, under control of the on-board control unit 14, contents of the left-behind article notification received by the on-board communication unit 13 in the cab and/or the like. When the on-board display unit 15 has capability of outputting a sound, the on-board display unit 15 may output a sound such as an alarm to cause the driver and the conductor working on the train 10 to be aware that a left-behind article notification has been received. This enables at least one of the driver or the conductor working on the train 10 to recognize that there is a left-behind article in the vehicle indicated by the information of car number included in the left-behind article notification by checking contents of display on the on-board display unit 15 without inspecting for whether there is a left-behind article with respect to each vehicle of the train 10 which has finished operation. This thus enables the left-behind article to be collected immediately. As a result, the train interior monitoring system 40 can reduce additional work of inspection of each vehicle of the train 10 which has finished operation, to be performed by at least one of the driver or the conductor working on the train 10.

Note that, on the train 10, at least one of the driver or the conductor working on the train 10 may perform an operation to report that at least one of the driver or the conductor has checked the left-behind article notification to thereby cause the train 10 to send back an acknowledgment indicating that the left-behind article notification has been checked, to the video analysis server 33 of the ground base station 30. This enables the video analysis server 33 to recognize that the left-behind article notification has been checked. In addition, when no acknowledgment indicating that the left-behind article notification has been checked is sent back from the train 10 within a predetermined period, the video analysis server 33 may cause the ground communication unit 31 to send the left-behind article notification again. This enables the video analysis server 33 to increase the probability of recognition of the left-behind article notification by the driver or the conductor working on the train 10.

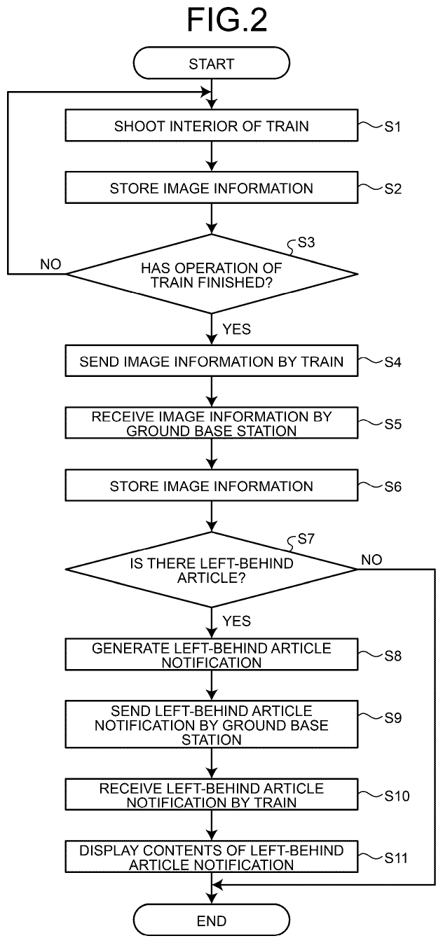

An operation of the train interior monitoring system 40 will next be described with reference to a flowchart. FIG. 2 is a flowchart illustrating an operation of the train interior monitoring system 40 according to the first embodiment. On the train 10, each of the surveillance cameras 11 periodically shoots an interior of the train 10 at a predetermined time cycle (step S1). The on-board video storage unit 12 stores, as image information, video data obtained by shooting by using the surveillance cameras 11 together with parameter information representing the situation of obtaining images by shooting (step S2). The on-board control unit 14 determines whether operation of the train 10 has finished (step S3). When operation of the train 10 has not finished (step S3: No), the train interior monitoring system 40 returns the process to the operation at step S1. When operation of the train 10 has finished (step S3: Yes), the on-board control unit 14 controls the on-board communication unit 13 to send therefrom the image information stored in the on-board video storage unit 12 to the ground communication unit 31 of the ground base station 30. That is, the on-board communication unit 13 of the train 10 sends the image information stored in the on-board video storage unit 12 to the ground communication unit 31 of the ground base station 30 (step S4).

In the ground base station 30, the ground communication unit 31 receives the image information sent from the on-board communication unit 13 of the train 10 via the ground-to-vehicle network 20 (step S5). The ground video storage unit 32 stores the image information received by the ground communication unit 31 (step S6). The video analysis server 33 determines whether there is a left-behind article on the train 10, using the image information stored in the ground video storage unit 32 (step S7). When there are no left-behind articles (step S7: No), the train interior monitoring system 40 terminates the operation of the flowchart illustrated in FIG. 2. When there is a left-behind article (step S7: Yes), the video analysis server 33 generates a left-behind article notification indicating that there is a left-behind article (step S8). The ground communication unit 31 of the ground base station 30 sends the left-behind article notification generated by the video analysis server 33 to the on-board communication unit 13 of the train 10 (step S9).

On the train 10, the on-board communication unit 13 receives the left-behind article notification sent from the ground communication unit 31 of the ground base station 30 via the ground-to-vehicle network 20 (step S10). The on-board control unit 14 causes the on-board display unit 15 to display contents of the left-behind article notification received by the on-board communication unit 13. That is, the on-board display unit 15 displays contents of the left-behind article notification, under control of the on-board control unit 14 (step S11).

Next, a hardware configuration of the train interior monitoring system 40 according to the first embodiment will be described. In the train interior monitoring system 40, the surveillance cameras 11 are sensors. In the train interior monitoring system 40, other components are implemented in processing circuitry. The processing circuitry may be a combination of a memory storing a program and a processor that executes a program stored in the memory, or a dedicated hardware element. The processing circuitry is also called a control circuit.

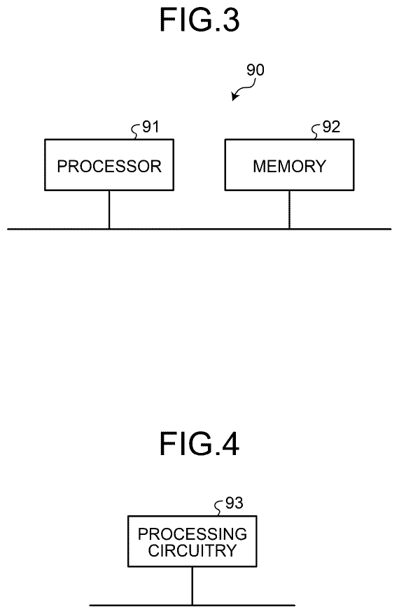

FIG. 3 is a diagram illustrating an example of a configuration of processing circuitry of the train interior monitoring system 40 according to the first embodiment when processing circuitry 90 is implemented by a processor 91 and a memory 92. The processing circuitry 90 illustrated in FIG. 3 is a control circuit, and includes a processor 91 and a memory 92. When the processing circuitry 90 includes the processor 91 and the memory 92, each functionality of the processing circuitry 90 is implemented in software, firmware, or a combination of software and firmware. The software or firmware is described in the form of a program, and is stored in the memory 92. The processing circuitry 90 implements each functionality in such a manner that the processor 91 reads and executes a program stored in the memory 92. That is, the processing circuitry 90 includes the memory 92 for storing a program that causes processing of the train interior monitoring system 40 to be performed. It can also be said that this program is a program for causing the train interior monitoring system 40 to perform each functionality to be implemented in the processing circuitry 90. This program may be provided using a storage medium storing the program or using another means such as a communication medium.

The foregoing program can also be said to be a program that causes the train interior monitoring system 40 to perform a first step in which the on-board video storage unit 12 stores, as image information, video data obtained by shooting an interior of the train 10 using the surveillance cameras 11 for shooting the interior of the train 10, together with parameter information representing a situation of obtaining the video data by shooting; a second step in which the on-board communication unit 13 sends, under control of the on-board control unit 14, the image information stored in the on-board video storage unit 12 to the ground communication unit 31 when the train 10 is in a stoppage state, where the on-board control unit 14 controls operations of devices installed on the train 10; a third step in which the ground communication unit 31 receives the image information sent from the on-board communication unit 13; a fourth step in which the video analysis server 33 determines whether there is a left-behind article on the train 10 using the image information received by the ground communication unit 31; a fifth step in which when the video analysis server 33 detects presence of a left-behind article, the video analysis server 33 generates a left-behind article notification indicating that there is a left-behind article; a sixth step in which the ground communication unit 31 sends the left-behind article notification to the on-board communication unit 13; a seventh step in which the on-board communication unit 13 receives the left-behind article notification; and an eighth step in which the on-board display unit 15 displays, under control of the on-board control unit 14, contents of the left-behind article notification received by the on-board communication unit 13.

In this respect, the processor 91 is, for example, a central processing unit (CPU), a processing unit, a computing unit, a microprocessor, a microcomputer, a digital signal processor (DSP), or the like. In addition, the memory 92 is, for example, a non-volatile or volatile semiconductor memory such as a random access memory (RAM), a read only memory (ROM), a flash memory, an erasable programmable ROM (EPROM), or an electrically erasable programmable ROM (EEPROM) (registered trademark); a magnetic disk, a flexible disk, an optical disk, a compact disc, a MiniDisc, a digital versatile disc (DVD), or the like.

FIG. 4 is a diagram illustrating an example of a configuration of the processing circuitry of the train interior monitoring system 40 according to the first embodiment when processing circuitry 93 is implemented in a dedicated hardware element. The processing circuitry 93 illustrated in FIG. 4 is, for example, a single circuit, a set of multiple circuits, a programmed processor, a parallel programmed processor, an application specific integrated circuit (ASIC), a field programmable gate array (FPGA), or a combination thereof. The processing circuitry 93 may be implemented partially in a dedicated hardware element and partially in software or firmware. Thus, the processing circuitry 93 can implement each functionality described above in a dedicated hardware element, software, firmware, or a combination thereof.

As described above, according to the present embodiment, the train interior monitoring system 40 operates in such a manner that the on-board communication unit 13 of the train 10 sends, under control of the on-board control unit 14, image information stored in the on-board video storage unit 12 to the ground base station 30 after finishing of the operation of the train 10, which period corresponds to the stoppage state of the train 10.

In the ground base station 30, the video analysis server 33 determines whether there is a left-behind article on the train 10 using the image information sent from the on-board communication unit 13 of the train 10 and received by the ground communication unit 31 of the ground base station 30. When the video analysis server 33 detects a left-behind article, the ground communication unit 31 of the ground base station 30 sends a left-behind article notification generated by the video analysis server 33 to the train 10. On the train 10, the on-board display unit 15 displays, under control of the on-board control unit 14, contents of the left-behind article notification received by the on-board communication unit 13. This enables at least one of the driver or the conductor working on the train 10 to recognize that there is a left-behind article in the vehicle indicated by information of car number included in the left-behind article notification by checking contents of display on the on-board display unit 15, and to thereby collect the left-behind article. In addition, during running of the train 10, the train interior monitoring system 40 does not send any image information from the train 10 to the ground base station 30, and does not send any left-behind article notification from the ground base station 30 to the train 10. Thus, the train interior monitoring system 40 can detect a left-behind article present on the train 10 while reducing the amount of data of communication during running of the train 10.

### Second Embodiment

In the first embodiment, each of the trains 10 (hereinafter referred to simply as the train 10) sends image information stored in the on-board video storage unit 12 to the ground base station 30 after finishing of the operation of that train 10, which period corresponds to the stoppage state of the train 10. A second embodiment will be described with respect to a case where the train 10 sends image information stored in the on-board video storage unit 12 to the ground base station 30 when the train 10 is making a stop at a station, which period corresponds to the stoppage state of the train 10.

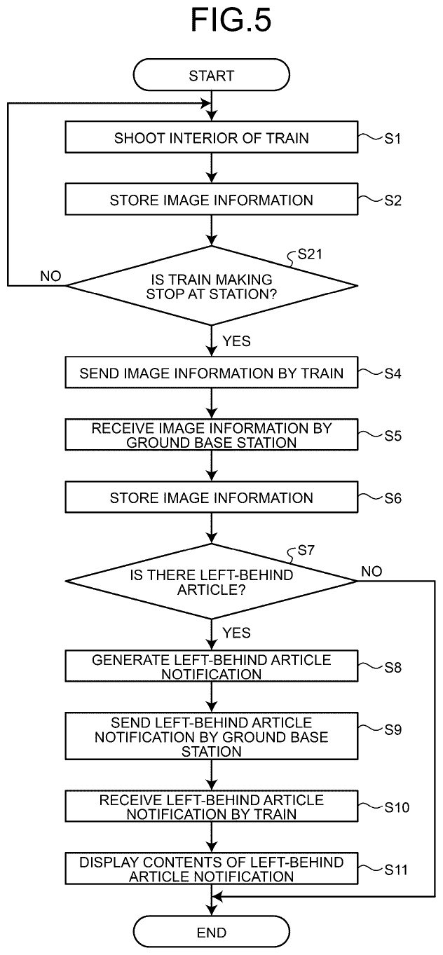

In the second embodiment, the train interior monitoring system 40 is configured similarly to the train interior monitoring system 40 in the first embodiment illustrated in FIG. 1. FIG. 5 is a flowchart illustrating an operation of the train interior monitoring system 40 according to the second embodiment. The flowchart of the second embodiment illustrated in FIG. 5 differs from the flowchart of the first embodiment illustrated in FIG. 2 in that step S3 is replaced with step S21.

In the second embodiment, the on-board control unit 14 determines, after the operation of step S2, whether the train 10 is making a stop at a station (step S21). As described above, the on-board control unit 14 controls operations of devices installed on the train 10. Accordingly, when, for example, doors of the train 10 are open, the train interior monitoring system 40 can recognize that the train 10 is making a stop at a station. When the train 10 is not making a stop at a station (step S21: No), the train interior monitoring system 40 returns the process to the operation at step S1. When the train 10 is making a stop at a station (step S21: Yes), the on-board control unit 14 controls the on-board communication unit 13 to send therefrom the image information stored in the on-board video storage unit 12 to the ground communication unit 31 of the ground base station 30. That is, the on-board communication unit 13 of the train 10 sends the image information stored in the on-board video storage unit 12 to the ground communication unit 31 of the ground base station 30 (step S4). Specifically, the on-board communication unit 13 of the train 10 sends, to the ground communication unit 31 of the ground base station 30, the image information that has been stored in the on-board video storage unit 12 during a time period from arrival at a station of a previous stop to arrival at a station of a current stop of the train 10, under control of the on-board control unit 14. In the second embodiment, the train interior monitoring system 40 performs other operations similarly to the train interior monitoring system 40 in the first embodiment. However, unlike the case of the first embodiment, the train interior monitoring system 40 performs sending and receiving of image information, determination of whether there is a left-behind article, and the like each time the train 10 makes a stop at a station, meaning that the train interior monitoring system 40 iterates the process of the flowchart illustrated in FIG. 5 during operation of the train 10.

For example, in a case where the train 10 is a train type of a long distance operation, and a passenger who got on the train 10 at a station near the starting station of the train 10 has left a belonging thereof on the train 10, the train interior monitoring system 40 that performs the operation of the first embodiment will detect the left-behind article at the terminal station far from the starting station. This will require a time and an additional work in both cases where the passenger himself or herself goes and collects the left-behind article and where the railroad company that operates the trains 10 transports the left-behind article to a station where the passenger wants.

On the other hand, in the second embodiment, even in a case where the train 10 is a train type of a long distance operation, and a passenger who got on the train 10 at a station near the starting station of the train 10 has left a belonging thereof on the train 10, the train interior monitoring system 40 can detect the left-behind article at a station not so far from the station where the passenger got off, by performing the operation of the second embodiment. In this case, sending the left-behind article notification also to a station where the left-behind article can be collected, by the train interior monitoring system 40, allows a staff person of the station who has checked the left-behind article notification to collect the left-behind article left on the train 10 even when the driver or the conductor of the train 10 failed to collect the left-behind article. This can reduce the time and the additional work as compared to the case of the first embodiment in both cases where the passenger himself or herself goes and collects the left-behind article and where the railroad company that operates the trains 10 transports the left-behind article to a station where the passenger wants.

As described above, according to the present embodiment, the train interior monitoring system 40 operates in such a manner that the on-board communication unit 13 of the train 10 sends, under control of the on-board control unit 14, the image information stored in the on-board video storage unit 12 to the ground base station 30 when the train 10 has made a stop at a station, which period corresponds to the stoppage state of the train 10.

Thus, the train interior monitoring system 40 enables the left-behind article to be collected at a station relatively near the location where the left-behind article was left as compared to the case of the first embodiment.

Note that the train interior monitoring system 40 has been described such that the train 10 sends image information to the ground base station 30 each time the train 10 makes a stop at a station, but the operation is not limited thereto. In the train interior monitoring system 40, the train 10 may be designed to send image information to the ground base station 30 when a large number of passengers are expected to get on and off at a station such as a transfer station for another railroad line and the stoppage time at that station is longer than a predetermined time period. That is, the train 10 does not need to send image information to the ground base station 30 when the stoppage time at the station is shorter than a predetermined time period.

### Third Embodiment

In the first embodiment, the train 10 sends image information stored in the on-board video storage unit 12 to the ground base station 30 after finishing of the operation of the train 10, which period corresponds to the stoppage state of the train 10, and the video analysis server 33 of the ground base station 30 determines whether there is a left-behind article using the image information. In this case, the video analysis server 33 of the ground base station 30 can further detect a passenger who is left on the train 10 which has finished operation, through an operation similar to the foregoing operation.

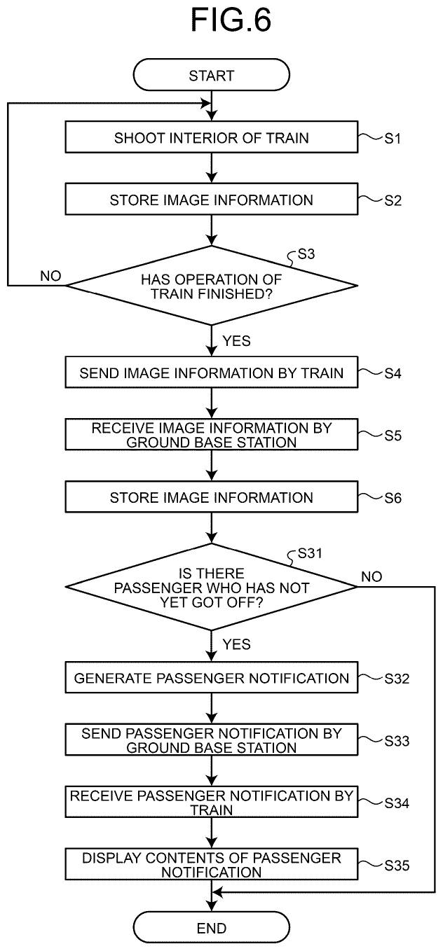

In the third embodiment, the train interior monitoring system 40 is configured similarly to the train interior monitoring system 40 in the first embodiment illustrated in FIG. 1. FIG. 6 is a flowchart illustrating an operation of the train interior monitoring system 40 according to the third embodiment. The flowchart of the third embodiment illustrated in FIG. 6 differs from the flowchart of the first embodiment illustrated in FIG. 2 in that steps S7 to S11 are replaced with steps S31 to S35.

In the third embodiment, the video analysis server 33 determines, after the operation of step S6, whether there is a passenger who has not yet got off the train 10 using the image information stored in the ground video storage unit 32 (step S31). When there is no passenger who has not yet got off (step S31: No), the train interior monitoring system 40 terminates the operation of the flowchart illustrated in FIG. 6. When there is a passenger who has not yet got off (step S31: Yes), the video analysis server 33 generates a passenger notification indicating that there is a passenger who has not yet got off (step S32). The passenger notification has contents similar to the contents of the left-behind article notification described in connection with the first embodiment. The ground communication unit 31 of the ground base station 30 sends the passenger notification generated by the video analysis server 33 to the on-board communication unit 13 of the train 10 (step S33).

On the train 10, the on-board communication unit 13 receives the passenger notification sent from the ground communication unit 31 of the ground base station 30 via the ground-to-vehicle network 20 (step S34). The on-board control unit 14 causes the on-board display unit 15 to display contents of the passenger notification received by the on-board communication unit 13. That is, the on-board display unit 15 displays contents of the passenger notification, under control of the on-board control unit 14 (step S35). When the on-board display unit 15 has a function of outputting a sound, the on-board display unit 15 may output a sound such as an alarm to cause the driver or the conductor working on the train 10 to be aware that a passenger notification has been received. In the third embodiment, the train interior monitoring system 40 performs other operations similarly to the train interior monitoring system 40 in the first embodiment. However, in the third embodiment, the term “left-behind article notification” in FIG. 1 is to be read as “passenger notification”, and the phrase “image information corresponding to left-behind article” in FIG. 1 is to be read as “image information corresponding to passenger”. The train interior monitoring system 40 performs the operation of the flowchart according to the third embodiment illustrated in FIG. 6 in parallel with the operation of the flowchart according to the first embodiment illustrated in FIG. 2.

Note that, on the train 10, at least one of the driver or the conductor working on the train 10 may perform an operation to report that at least one of the driver or the conductor has checked the passenger notification to thereby cause the train 10 to send back an acknowledgment indicating that the passenger notification has been checked, to the video analysis server 33 of the ground base station 30. This enables the video analysis server 33 to recognize that the passenger notification has been checked. In addition, when no acknowledgment indicating that the passenger notification has been checked is sent back from the train 10 within a predetermined period, the video analysis server 33 may generate a passenger notification again, and cause the ground communication unit 31 to send the passenger notification again. This enables the video analysis server 33 to increase the probability of recognition of the passenger notification by the driver or the conductor working on the train 10.

As described above, according to the present embodiment, the train interior monitoring system 40 operates in such a manner that the video analysis server 33 of the ground base station 30 determines whether there is a passenger who has not yet got off the train 10 using the image information sent from the on-board communication unit 13 of the train 10 and received by the ground communication unit 31 of the ground base station 30. When the video analysis server 33 detects a passenger who has not yet got off, the ground communication unit 31 of the ground base station 30 sends the passenger notification generated by the video analysis server 33 to the train 10. On the train 10, the on-board display unit 15 displays, under control of the on-board control unit 14, contents of the passenger notification received by the on-board communication unit 13. This enables at least one of the driver or the conductor working on the train 10 to recognize that there is a passenger in the vehicle indicated by information of car number included in the passenger notification by checking contents of display on the on-board display unit 15, and to thereby protect the passenger who is left on the train 10.

The configurations described in the foregoing embodiments are merely examples. These configurations may be combined with another known technology, and the configurations of the different embodiments may be combined together. Moreover, part of such configurations may be omitted and/or modified without departing from the spirit.

### REFERENCE SIGNS LIST

10a, 10b train; 11 surveillance camera; 12 on-board video storage unit; 13 on-board communication unit; 14 on-board control unit; 15 on-board display unit; 20 ground-to-vehicle network; 30 ground base station; 31 ground communication unit; 32 ground video storage unit; 33 video analysis server; 34 lost article management server; 40 train interior monitoring system; 90, 93 processing circuitry; 91 processor ; 92 memory.

1. A train interior monitoring system comprising:
an on-board memory to store, as image information, video data and parameter information, the video data obtained by shooting an interior of a train using a surveillance camera, the parameter information representing a situation of obtaining the video data by shooting;
on-board control circuitry to control operation of a device installed on the train;
on-board display provide a display under control of the on-board control-unit circuitry;
on-board communication circuitry to send, under control of the on-board control circuitry, the image information stored in the on-board memory to a ground communication circuitry when the train is in a stoppage state;
the ground communication circuitry to receive the image information sent from the on-board communication circuitry; and
video analysis circuitry to determine whether there is a left-behind article on the train using the image information received by the ground communication circuitry, wherein
when the video analysis circuitry detects presence of the left-behind article, the video analysis circuitry generates a left-behind article notification indicating that there is the left-behind article,
the ground communication circuitry sends the left-behind article notification to the on-board communication circuitry,
the on-board communication circuitry receives the left-behind article notification, and
the on-board display displays, under control of the on-board control circuitry, a content of the left-behind article notification received by the on-board communication circuitry.

2. The train interior monitoring system according to claim 1, wherein
the stoppage state of the train is a state in which operation of the train has finished, and
the on-board communication circuitry sends, under control of the on-board control circuitry, the image information stored in the on-board memory during a time period from start of operation of the train to end of operation of the train, to the ground communication circuitry.

3. The train interior monitoring system according to claim 1, wherein
the stoppage state of the train is a state in which the train is making a stop at a station, and
the on-board communication circuitry sends, under control of the on-board control circuitry, the image information stored in the on-board memory during a time period from arrival at a station of a previous stop of the train to arrival at a station of a current stop of the train, to the ground communication circuitry.

4. The train interior monitoring system according to claim 1, wherein
the left-behind article notification includes information of car number indicating a vehicle that constitutes the train for allowing identification of a location of the left-behind article, among the parameter information corresponding to the video data of the left-behind article that has been shot.

5. The train interior monitoring system according to claim 4, wherein
the left-behind article notification further includes the video data of the left-behind article that has been shot.

6. The train interior monitoring system according to claim 1, further comprising:
a lost article management circuitry to store the image information corresponding to the left-behind article.

7. The train interior monitoring system according to claim 2, wherein
the video analysis circuitry further determines whether there is a passenger who has not yet got off the train, and when there is the passenger who has not yet got off, the video analysis circuitry generates a passenger notification indicating that there is the passenger who has not yet got off,
the ground communication circuitry sends the passenger notification to the on-board communication circuitry,
the on-board communication circuitry receives the passenger notification, and
the on-board display displays, under control of the on-board control circuitry, content of the passenger notification received by the on-board communication circuitry.

8. A train interior monitoring method comprising:
storing in a memory of a train, as image information, video data and parameter information, the video data obtained by shooting an interior of the train, the parameter information representing a situation of obtaining the video data by shooting;
sending the image information stored in the memory to a ground base station when the train is in a stoppage state;
receiving the image information sent from the train;
determining whether there is a left-behind article on the train using the image information received by the ground base station;
generating a left-behind article notification indicating that there is the left-behind article, when the ground base station detects presence of the left-behind article;
sending the left-behind article notification to the train;
receiving the left-behind article notification by the train; and
displaying a content of the left-behind article notification received by the train.

9. The train interior monitoring method according to claim 8, wherein
the stoppage state of the train is a state in which operation of the train has finished, and
in the sending the image information stored in the memory, the train sends the image information stored in the memory during a time period from start of operation of the train to end of operation of the train, to the ground base station.

10. The train interior monitoring method according to claim 8, wherein
the stoppage state of the train is a state in which the train is making a stop at a station, and
in the sending the image information stored in the memory, the train sends the image information stored in the memory during a time period from arrival at a station of a previous stop of the train to arrival at a station of a current stop of the train, to the ground base station.

11. The train interior monitoring method according to claim 8, wherein
the left-behind article notification includes information of car number indicating a vehicle that constitutes the train for allowing identification of a location of the left-behind article, among the parameter information corresponding to the video data of the left-behind article that has been shot.

12. The train interior monitoring method according to claim 11, wherein
the left-behind article notification further includes the video data of the left-behind article that has been shot.

13. The train interior monitoring method according to claim 8, further comprising:
storing the image information corresponding to the left-behind article in a memory of a lost article management circuitry.

14. The train interior monitoring method according to claim 9, further comprising:
determining whether there is a passenger who has not yet got off the train;
when there is the passenger who has not yet got off, generating a passenger notification indicating that there is the passenger who has not yet got off;
sending the passenger notification to the train;
receiving the passenger notification; and
displaying a content of the passenger notification received by the train.
